(19) United States
(12) Patent Application Publication
(10) Pub. No.: US 2006/0109384 A1
(43) Pub. Date: May 25, 2006

(54) Power management in appliances

(75) Inventors: Richard M Miller-Smith, Lingfield (GB); David E. Penna, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninkliklijke Philips Electronics N.V., Eindhoven (NL)

(21) Appl. No.: 10/539,897

(22) PCT Filed: Dec. 10, 2003
(86) PCT No.: PCT/IB03/05996

§ 371 Date: Jun. 16, 2005

(30) Foreign Application Priority Data
Dec. 21, 2002 (GB) 0229899.0

(51) Int. Cl. H04N 7/16; H04N 7/00

(52) U.S. Cl. 348/730; 348/552; 725/153

(57) ABSTRACT

An appliance, such as a set top box, has an ON power mode and a STAND BY power mode and is in communication with a television set. A parameter of an operating signal associated with the television set is monitored and the value of the parameter is compared with predetermined values at which the set top box is desired to be either operative (ON power mode) or inoperative (STAND BY power mode). When a predetermined value of the parameter is detected, the current power mode of the set top box is evaluated and, if necessary, changed. Power supply to the TV set, operating frequency of a local oscillator/mixer in the TV set or the presence of a line scan signal from the TV set rate can be monitored to determine whether the appliance should be turned on or off.

The present invention relates to improved power management in consumer appliances which output video signals for display through a users' television set, such as set top boxes (STBs).

STBs receive broadcasting signals from, for example, cable, digital or satellite service providers. The signals are typically fed to a single channel of the associated television set. Other channels are typically reserved for terrestrial television signals, VHS/DVD players or games consoles. Once tuned to the STB signal-receiving channel, a variety of different broadcast signals can be selected for viewing through that channel.

It will be appreciated that a significant amount of power is consumed by a STB when receiving a large number of broadcast signals from a service provider, power that is wasted when none of the broadcasts are being viewed or heard by a user.

In order to conserve energy, modern electronic appliances are commonly provided with a “stand-by” mode. When in this mode, the appliance is essentially switched off, except for a receiving circuit, which is configured to receive a reset signal, for example an infrared signal emitted by a remote control hand set. This mode enables energy that might otherwise be used to power the appliance, to be conserved without the need for disconnecting the appliance from its main power supply.

It is known from U.S. Pat. No. 6,292,943 B1 to provide a power control method for a STB. That method is specifically directed to signalling a STB which is in a “stand-by” mode to switch on and to transmit a broadcast programme which has been selected for recording on a video cassette recorder (VCR). In the method, a VCR is programmed to record a specified program at a specified time. When the VCR prepares to record at the specified time, a signal is sent to the STB to ensure that the STB is switched on and ready to relay the signal associated with the selected programme for recording by the VCR.

An object of the present invention is to reduce energy consumption of an appliance which outputs a video signal.

According to a first aspect, the present invention provides a power control method for an appliance which outputs a video signal for display on a television set, the appliance having an ON power mode and a STAND BY power mode and being in communication with the television set, the method comprising;

monitoring a parameter of an operating signal associated with the television set;

comparing the value of the parameter with predetermined values at which the appliance is desired to be either operative (ON power mode) or inoperative (STAND BY power mode); and,

evaluating, when a predetermined value of the parameter is detected, the current power mode of the appliance and if this is not the desired power mode, initiating a change in operation of the appliance from its current power mode to the desired power mode.

In one simple embodiment, the operating signal is the electricity supply passing through the power cord to the television set. Optionally, the parameter monitored is the electric current passing through the power cord. It will be understood that when the television set is switched on so as to display a broadcast programme, the electric current will be significantly higher than when the set is switched off or in stand by mode. In such an arrangement, when a predetermined electric current value, higher than that associated with the television set being off or in stand by mode is detected, operation of the appliance in ON power mode is initiated. When the electric current value falls below this predetermined value, the operation of the appliance is switched to stand by mode. Thus, the appliance can be configured to switch to its ON mode, automatically, when the television set is on, or to its STAND BY mode when the television set is switched off or to stand by. It is to be understood that whilst the specific example of current is given here, with suitable sensors, other variable parameters of the electricity supply could be monitored without materially affecting the mode of operation of this embodiment.

This first embodiment of the method may be effected by a suitably adapted electrical socket into which the power cable of the television set is plugged and which is in electrical communication with a controller for the appliance. Sensors in the socket monitor a chosen parameter (e.g. current, voltage or resistance) passing to the power cable and the television set, when the sensors detect that a pre-determined value, for example, of the electric current has been reached or exceeded, this information is relayed to the controller which in turns signals the appliance to power up to full ON power mode. Conversely, when the sensors detect that the current monitored has fallen below the predetermined value, the controller signals the appliance to power down to STAND BY mode.

In an alternative embodiment, the operating signal monitored is the frequency of the oscillator/mixer of the television set. One particular frequency will define the channel through which the services received by the appliance are carried to the TV. When this pre-determined frequency is detected, the appliance is operated in full ON power mode, when the frequency is other than the pre-determined frequency, the appliance is operated in STAND BY mode.

Such an embodiment of the method can be effected with the use of an RF cable connecting the controller of the appliance with the television set. Leakages down the RF cable can be monitored for occurrences of the pre-determined frequency. Detection of the pre-determined frequency signals a controller of the appliance to operate the box in ON power mode. Detection of a different frequency, or zero frequency, signals the controller to operate the box in STAND BY mode.

In another alternative embodiment, the operating signal is the line scan of images displayed on the screen of the associated television set (having a cathode ray tube display). Thus, the predetermined ‘value’ may be the presence or absence of a line scan. Magnetic field detection can be used as a means of detecting the line scan rate.

In a more complex version of this embodiment, line scans may incorporate signatures which can be recognised by a controller of the appliance as relating to a broadcast made by the service provider whose broadcasts the appliance is configured to receive. The “parameter” monitored would be a signature of the line scan. Thus, in this more complex version, the appliance is configured to operate in ON mode only when the television set is on and the viewer is viewing a programme received through the appliance.

The signature of the line scan may be a subtle alteration of the timing and/or frequency of the line scan associated with a particular service provider. An alternative arrangement is possible, with the signature of the line scan being a n appliance generated signal. In this embodiment, even if there are multiple pieces of equipment connected to the TV (such as STBs, games consoles etc.) each one can uniquely identify it's own signal. In a digital system video is played out of a frame buffer and a system clock controlling the buffer can be altered.

Whatever parameter is actually monitored, the appliance can operate a system whereby it establishes a threshold level of the switching parameter. This could be done adaptively by observation. So, for example, the appliance could monitor power current for the TV over a period and find a high range and a low range of power usage (corresponding to on and standby). Having done this it could set the threshold in the gap between these ranges, for example at the halfway point. In this way, adaptive determination of the threshold is achieved.

Further aspects of the invention provide a power control apparatus for an appliance, an appliance incorporating the power control apparatus and a computer program for controlling operation of the power control apparatus.

Whilst embodiments in this specification describe a STB, it is to be understood that the invention may equally be applied to the power management of other TV peripherals such as DVD players, VCRs and games consoles.

For the purposes of exemplification, there now follows a brief description of some embodiments of the invention as shown in the accompanying Figures of which:

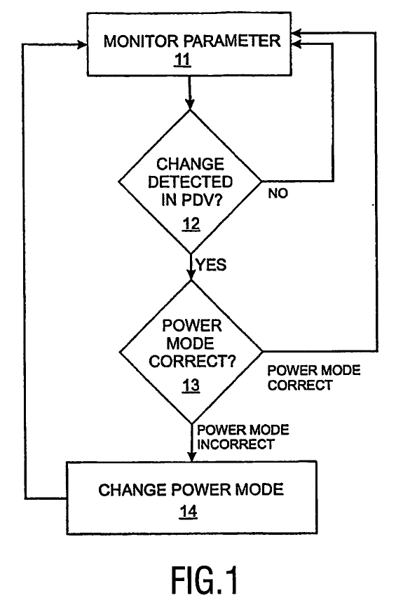

FIG. 1 shows, in flow chart form, the power management method performed by a controller of an appliance in accordance with the invention;

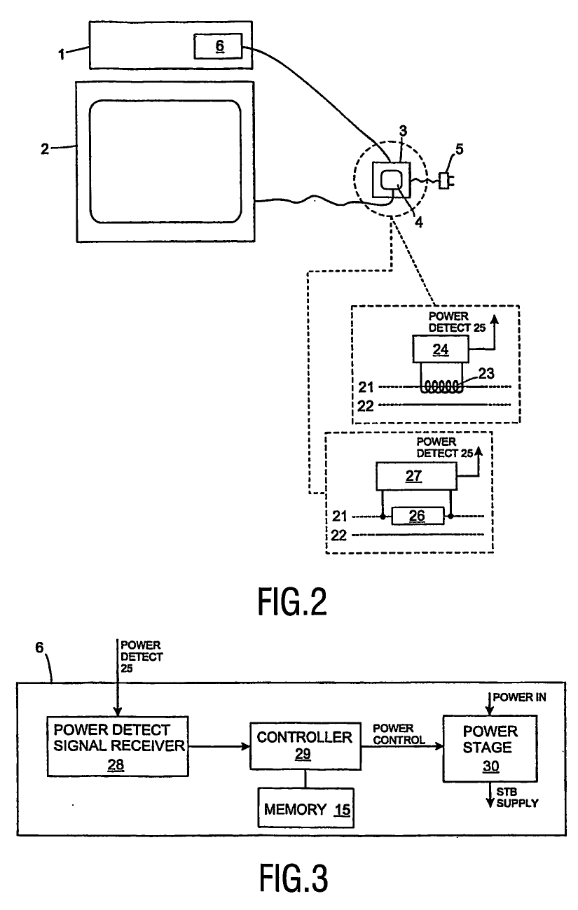

FIG. 2 shows an appliance and television set device for use in performing a first embodiment of the power management method of the invention, based on monitoring power supply to the television set;

FIG. 3 shows control functions of the appliance in FIG. 2;

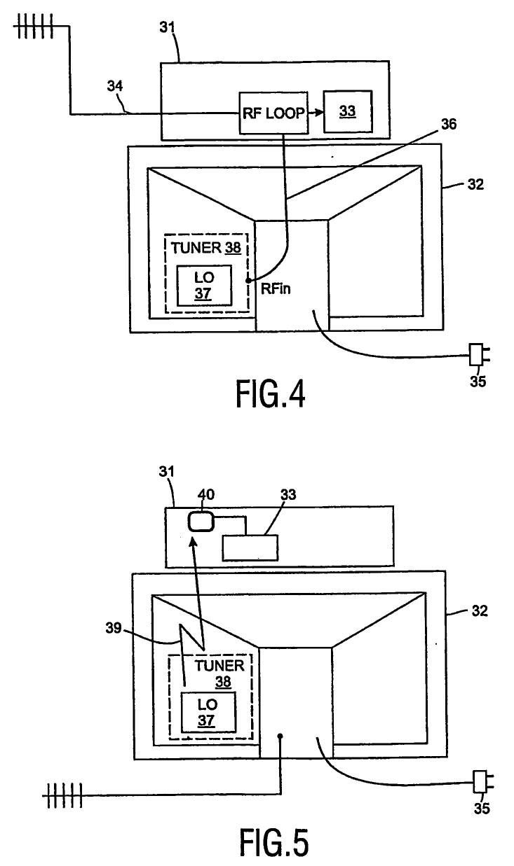

FIG. 4 shows apparatus for performing a second embodiment of the invention, based on monitoring a LO frequency;

FIG. 5 shows a variant of the second embodiment of the invention;

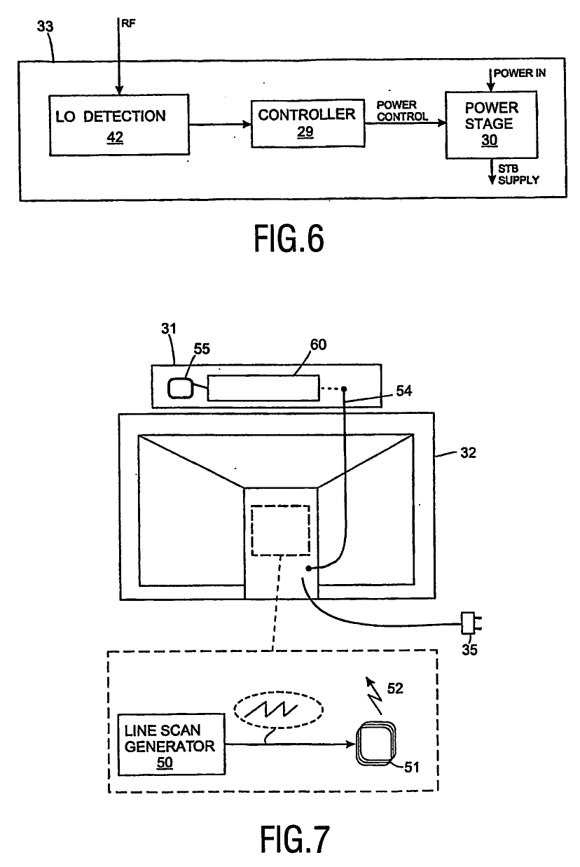

FIG. 6 shows control functions of the appliance in FIG. 4;

FIG. 7 shows apparatus for performing a third embodiment of the invention, based on monitoring line scan;

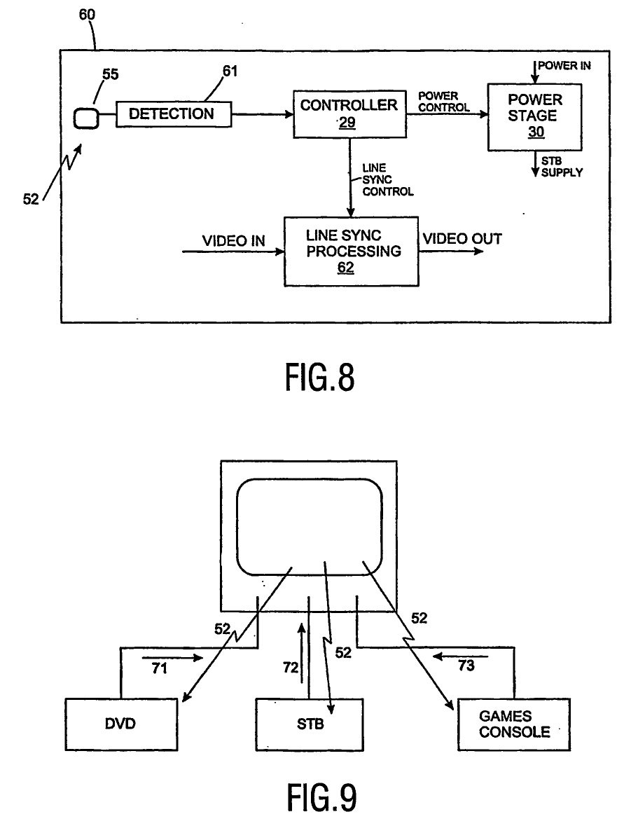

FIG. 8 shows control functions of the appliance in FIG. 7;

FIG. 9 shows a system with multiple appliances of the type shown in FIGS. 7 and 8.

FIG. 1 shows a flow chart for the overall method of power management of an appliance. Although reference will be made to a set top box (STB), the method is not limited to use with a STB. In step 11, a sensor forming part of a controller system for the STB, monitors a characteristic parameter of an operating signal associated with the television set, for example, the current associated with the power supply to the TV set. The controller is programmed to recognise one or more predetermined values of the measured parameter, for example a maximum and/or or minimum predetermined value (PDV) of the parameter which is associated with a recognisable state of the TV set. Where the parameter is the electrical current, the sensor/controller are programmed to recognise a minimum value above which the TV set is assumed to be in use, and the STB needed in its ON mode and/or a minimum value below which the TV set is assumed to be off or in stand by mode and the STB is required to be in its STAND BY mode. The maximum and/or minimum value (i.e. the predetermined value (PDV)) may be a single value of current. In step 12, if the sensor detects a change in the parameter with respect to the PDV (for example, the value of the parameter changes from a value above the PDV to a value below the PDV), the controller proceeds to step 13 and checks whether the current power mode of the STB matches the desired power mode for the given value of the parameter. If there is not a match, then the controller changes the power mode, at step 14, to the desired power mode.

As previously discussed, in other embodiments, the PDV may be, for example a frequency range consistent with frequencies through which the STB signal is received by the TV set, or a line scan signature unique to the provider of the broadcast service received by the STB. The power mode is checked whenever the value of the monitored parameter falls outside or into the range.

FIGS. 2 and 3 illustrate a first embodiment of the invention. As can be seen, a STB 1 is associated with a TV set 2. The power plug 4 for the TV set 2 is received by a socket 3. The socket 3, in turn, is equipped with a power plug 5 which can be inserted into the mains power supply whereby to provide power for the STB 1, the socket 3 and the TV set 2. Socket 3 includes a sensor, two variations of which are shown in more detail, for detecting changes in electrical current passing through the socket. The sensor can take the form of a few turns of wire 23 wound around one of the wires in the power feed to the TV (either live or neutral). This acts like a small transformer. When the TV is operating, a small 50/60 Hz signal is detected 24 and used to provide an output signal 25 for sending to the STB. This technique provides safety isolation from the TV mains supply feed. In another technique, a low resistance component 26 is placed in series with one of the lines of the TV power feed. As before, when the TV is operating, a small signal appears across resistance 26 which is detected 27 and used to provide an output signal 25 for sending to the STB.

The socket is electronically connected with the STB 1 and communicates with the control unit 6 of the STB. The ‘power detect’ signal 25 can be communicated with the STB by power line communications signals, wireless (radio, IR) or a direct wired link. Referring to FIG. 3, the control unit 6 comprises a receiver 28 for receiving the power detect signal 25 from the socket 3. A controller 29, such as a microcontroller with control software stored on memory 15, performs the control logic and issues a power control signal to a power stage of the STB to turn the STB between an ON mode and a standby mode. Memory 15 also stores threshold levels for use in deciding when the power signal 25 detected by the sensor in the socket 4 is sufficient to turn the power stage on or off. When the TV set 2 is in its ON mode, it will drain more current from the power supply via the socket 4 than when it is switched off or in reduced power STAND BY mode. As previously discussed, the socket 3 communicates changes in current to the controller 6 of the STB 1, which in turn effects appropriate changes in the power mode of the STB.

The socket 3, including the sensor, and plug 5 can form an integrated unit with the appearance of a mains adapter.

In an alternative arrangement, not shown, the mains plug 4 for the TV is plugged into a socket on the STB, which supplies power looped through from the STB power input. All of the monitoring functions described above can then be housed within the STB.

FIGS. 4 to 6 show a second embodiment of the invention wherein a STB 31 includes a control unit 33 which is in communication with an RF cable 36 which in turn connects with a TV set 32. The TV set 32 also has an aerial 34 through which broadcasts are received, which connects through the STB 31, and a mains plug 35. The STB may also have its own power supply (not shown). The RF cable detects leakage from the oscillator/mixer 37 of the TV set 32 from which the frequency of signals viewed on the TV set can be determined. In a known manner, the local oscillator 37 generates a LO signal at a frequency which is sufficient to translate the required RF channel down to the tuner's IF frequency. The IF of the tuner is normally around 40 MHz and, as an example, the UHF band used for TV transmission covers the range 470-860 MHz. Thus, the LO frequency to be monitored will differ from this by 40 MHz.

Controller 29 is programmed to recognise as a PDV a frequency, or frequency range, associated with broadcasts viewed through the STB. When such frequencies are detected, the controller switches the STB to its ON mode. When the detected frequency falls outside the range; the controller switches the STB to STAND BY mode. A STB will usually output a channel, selected by a user on the STB's remote control, on a single RF channel and the TV will be tuned to that RF channel. In this case, the frequency monitored by the STB is the LO frequency necessary to translate the RF output channel to the IF of the TV. Frequency values can be stored in a memory associated with controller 29.

This technique makes use of the realisation that local oscillator signals leak where they shouldn't. Thus, some of the LO signals will return from the tuner to the aerial input. Even though the RF cable between the STB and TV is screened, the cable passes signals which have already been picked up within the TV.

In an alternative embodiment, shown in FIG. 5, an internally mounted antenna 40 within the STB is used to detect emissions originating from the LO.

FIG. 6 shows control unit 33, with similar features having the same reference numerals as previously shown in FIG. 3.

FIG. 7 shows a third embodiment of the invention. TV sets 32 with a cathode ray tube (CRT) type of display use a scanning technique to display an image. Line scan in a CRT-based TV is normally magnetic. Taking a PAL signal as an example, the frame rate is 25 Hz and there are 625 lines per frame, giving a line rate of 25×625=15.625 KHz. Line deflection is achieved by passing a waveform at this rate through a coil 51 around the neck of the CRT, which deflects the CRT beam from left to right. The consequence of this is that there will normally be a significant magnetic field detectable even outside the TV set. This is a relatively high power circuit and often, for reasons of economy of circuitry, this high power line scan circuit 50 is also used to provide input to the transformer which generates the EHT voltage (˜25 KV) used to accelerate the electron beam. Given all of this high power circuitry running at the line rate, a signal at the line rate can be detected in STB 31 positioned near the TV 32. An antenna or magnetic field pick-up 55 is housed within the STB 31.

In a further development of this embodiment, the STB modifies the video signal which is fed to the TV set 32. A control unit for achieving this is shown in FIG. 8. Controller 29 varies the timing of the line synchronisation signals in the output video signal to the TV to introduce a signature. This can be achieved by applying a line sync control signal to a line sync processing unit 62. Line scan signals from the TV are detected by a pick-up 55 and detection circuit 61. Controller 29 monitors the line scan frequency. If perturbations in the line scan timing are the same as those being introduced by the controller 29, then the STB knows that the TV is displaying this signal. Similarly, if the perturbations are not detected, the STB knows that the TV is not currently displaying the output of the STB. The perturbations must be carefully controlled so as not to unduly affect the synchronisation of the TV. Preferably, the line sync pulses which occur during field blanking, when no visible material is being transferred, are manipulated.

The method of monitoring a TV can include two steps. In a first step, controller 29 monitors just for the presence of a line scan, which will indicate whether the TV is displaying a video signal at all. If no line scan is present, then the STB can switch to stand by. However, if a line scan is found, then the controller 29 can begin to introduce a signature into the video signal and monitor for the presence of that signature, as previously described, to determine whether the video signal being displayed is the signal output from the STB.

FIG. 9 shows a system with three appliances: a STB, a DVD player and a games console. Each appliance can introduce a signature into its video output signal 71, 72, 73 and monitor the line scan emissions 52 of the TV to determine whether a video signal with the signature introduced by the appliance is being displayed by the TV. If the TV is not displaying the signal, then that appliance can decide to power down.

1. A power control method for an appliance (1) which outputs a video signal for display on a television set (2), the appliance having an ON power mode and a STAND BY power mode and being in communication with the television set, the method comprising;
monitoring a parameter of an operating signal associated with the television set (2);
comparing the value of the parameter with predetermined values at which the appliance is desired to be either operative (ON power mode) or inoperative (STAND BY power mode); and,
evaluating, when a predetermined value of the parameter is detected, the current power mode of the appliance (1) and if this is not the desired power mode, initiating a change in operation of the appliance (1) from its current power mode to the desired power mode.

2. A method as claimed in claim 1 wherein the operating signal is the electricity supply to the TV set (2).

3. A method as claimed in claim 2 wherein the parameter is the current of the electricity supply.

4. A method as claimed in claim 3 wherein a predetermined value corresponds to a minimum above which the TV set is known to be switched on.

5. A method as claimed in claim 1 wherein the operating signal is the TV signal displayed on the TV set and the parameter is the frequency at which the signal is received.

6. A method as claimed in claim 5 wherein a predetermined value is the frequency or frequency band at which the appliance receives services from the service provider whose broadcasts the appliance is configured to receive.

7. A method as claimed in claim 1 wherein the operating signal is the oscillator/mixer signal of the television set and the predetermined value is the frequency or frequency band of the oscillator/mixer signal.

8. A method as claimed in claim 1 wherein the operating signal is the line scan of images displayed by the TV set and the predetermined value is the presence or absence of a line scan.

9. A method as claimed in claim 8 wherein the line scan incorporates a signature unique to a broadcast service provider whose services are received through the appliance.

10. A method as claimed in claim 8 wherein the line scan incorporates a signature unique to the appliance.

11. A method as claimed in claim 9 or 10 wherein the predetermined value is the presence or absence of the signature.

12. A method as claimed in any one of the preceding claims wherein the predetermined value is adaptive.

13. A method as claimed in any one of the preceding claims wherein the appliance is a set top box (STB), a DVD player, a VCR or a games console.

14. A power control apparatus for an appliance (1) which outputs a video signal for display on a television set (2), the appliance (1) having an ON power mode and a STAND BY power mode and being in communication with the television set (2), the apparatus comprising;
means for monitoring a parameter of an operating signal associated with the television set;
means for comparing the value of the parameter with predetermined values at which the appliance is desired to be either operative (ON power mode) or inoperative (STAND BY power mode);
and means for evaluating, when a predetermined value of the parameter is detected, the current power mode of the appliance, and if this is not the desired power mode, initiating a change in operation of the appliance from its current power mode to the desired power mode.

15. A power control apparatus as claimed in claim 14 wherein the operating signal is the electricity supply to the TV set.

16. A power control apparatus as claimed in claim 15 further comprising an electrical socket (3) configured to receive the power plug (4) of the TV set (2), the socket (3) being electrically connectable to a mains electricity supply and including means (23, 24; 26, 27) for sensing changes in one or more characteristic parameters of the electricity supply passing through the socket and means for communicating the sensed changes to the control apparatus.

17. A power control apparatus as claimed in claim 14 wherein the operating signal is the TV signal displayed on the TV set and the parameter is the frequency at which the oscillator/mixer of the TV is operating, the apparatus further comprising means (42) for monitoring the frequency or frequency band to which the oscillator/mixer of the television set is tuned.

18. A power control apparatus as claimed in claim 17 wherein the monitoring means comprises an RF cable (36) coupling the appliance to the television set.

19. A power control apparatus as claimed in claim 14 wherein the operating signal is the line scan of images displayed by the TV set and the apparatus comprises means for monitoring the line scan.

20. A power control apparatus as claimed in claim 17 or 19 wherein the monitoring means comprises an antenna (40, 55) within the appliance.

21. A power control apparatus as claimed in claim 19 which is arranged to cause the appliance to incorporate a signature in the scan rate of the video signal which can be monitored by the apparatus.

22. A computer program for causing a power control apparatus to perform the method as claimed in any one of claims 1 to 13.

23. An appliance comprising an output for outputting a video signal for display on a television set and a power control apparatus as claimed in any one of claims 14 to 21 or a computer program as claimed in claim 22.

24. An appliance as claimed in claim 23 in the form of a set top box (STB), a DVD player, a VCR or a games console.
